(19) United States
(12) Patent Application Publication
(10) Pub. No.: US 2006/0126847 A1
(43) Pub. Date: Jun. 15, 2006

(54) System and method for establishing secure communications between devices in distributed wireless networks

(76) Inventor: Jin-Meng Ho, Plano, TX (US)

Correspondence Address: TEXAS INSTRUMENTS INCORPORATED, P O BOX 655474, M/S 3999, DALLAS, TX, 75265, US

(21) Appl. No.: 11/272,099

(22) Filed: Nov. 10, 2005

Related U.S. Application Data
(60) Provisional application No. 60/627,496, filed on Nov. 12, 2004.

(51) Int. Cl. H04L 9/00

(52) U.S. Cl. 380/277

(57) ABSTRACT

A method of establishing secure communications between devices in a network is described. According to an embodiment, messages included in pairwise temporal key (PTK) command frames and group temporal key (GTK) command frames are defined. According to another embodiment, service primitives representing message exchanges between management entities within a device are defined. According to another embodiment, method for using defined messages and primitives for a 4-way handshake to derive a PTK between two devices are also described.

### BACKGROUND

1. Field of the Invention

The invention relates to data communications and networking, and in particular, system and method for establishing secure communications between devices in a distributed wireless network.

1. Description of the Related Art

Generally, IEEE 802.11 based and other wireless networks require access points to coordinate and control medium access of devices in the network for wireless services. Services are interrupted or disabled in such networks when devices or access points move away from each other, when access points malfunction, or when access points do not coordinate among themselves, which is typically the case. Recently, a new generation of distributed wireless networks using high-speed, short-range ultra-wideband technology has been proposed by Multiband OFDM Alliance (MBOA) or WiMedia Alliance that does not require any existing infrastructure (such as access points) for communication. These networks can provide data throughput of up to about 500 Mbps. Protocols are defined for devices in a distributed wireless network to detect other devices within their neighborhood and establish communication with them without having to go through access points. The basic architecture of distributed wireless networks is defined by various specifications issued by WiMedia, such as “Distributed Medium Access Control (MAC) for Wireless Networks”, Draft 0.99, Nov. 1, 2005, which is incorporated herein by references in its entirety for all purposes.

Distributed wireless networks may be formed without a central coordinator like an access point to overcome those drawbacks. In such networks, devices transmit their beacons as means of coordinating their medium access. These beacons are transmitted periodically, or once every predetermined time interval called a superframe. The superframe is a periodic time interval for coordinating frame transmission between devices. The superframe includes a beacon period (BP) followed by a data period. The superframe may have a predetermined duration and is composed of several Medium Access Slots (MAS), each MAS having a duration. The superframe starts with a BP, which may include one or more MASs. The start of the first MAS in the BP is referred to as the beacon period start time (BPST). The BPST can be defined by a device operating in a wireless network.

When a device is turned on, it scans one or more communication channels to search for beacons from other devices in its neighborhood and selects a channel for communication. If the device detects one or more beacons in the selected channel, then the device synchronizes its BPST to that defined by the existing beacons in the selected channel and joins the group of devices having the same BPST. This group of devices is referred to as the beacon group (BG). These are logical groups of devices formed around each device to facilitate contention free frame exchanges between devices. If the device does not detect one or more beacons in the selected channel, then the device creates its own BP and sends a beacon on the selected channel to inform other devices that may later communicate in the selected channel. Each device operates in a dynamic environment and has capability to dynamically change the channel in which it operates without requiring either user intervention or causing the disruption of communications with its peers.

Distributed wireless networks present unique security challenges due to the loss of protection provided by physical wiring and shielding, due to the absence of a central coordinator that could otherwise act as a security server, due to the wide range of applications and use models that they must support, etc. For example, eavesdroppers can overhear data exchanges not intended for them, whereas imposters can send forged data not using its own identity, can replay previously transmitted data, and can transmit modified data captured from a previous transmission. Therefore, there is a need for a system and method for establishing secure communications between devices in such distributed wireless networks.

### SUMMARY

Accordingly, a system and method for establishing secure communications between devices in a distributed system are defined. According to an embodiment, messages included in pairwise temporal key (PTK) command frames are defined. These messages are used in a 4-way handshake to authenticate two devices to each other and derive a PTK for securing unicast traffic between the two devices. According to another embodiment, messages included in a group temporal key (GTK) command frames are defined. These messages are used to solicit or distribute a GTK for securing certain multicast or broadcast traffic. Further, service primitives representing message exchanges between management entities within a device are defined. These messages are used to manage and handle security operations such as 4-way handshake and temporal key update.

The foregoing is a summary and thus contains, by necessity, simplifications, generalizations and omissions of detail; consequently, those skilled in the art will appreciate that the summary is illustrative only and is not intended to be in any way limiting. As will also be apparent to one of skill in the art, the operations disclosed herein may be implemented in a number of ways, and such changes and modifications may be made without departing from this invention and its broader aspects. Other aspects, inventive features, and advantages of the present invention, as defined solely by the claims, will become apparent in the non-limiting detailed description set forth below.

### DESCRIPTION OF THE DRAWINGS

FIG. 1 illustrates an architecture of a distributed wireless network 100 with reference to standard OSI reference model according to an embodiment;

FIG. 2 illustrates an exemplary format of a MAC header 200 according to an embodiment.

FIG. 3 illustrates an exemplary format of a Frame Control filed 250 according to an embodiment.

FIG. 4 illustrates an exemplary format of a Pairwise Temporal Key (PKT) command frame 400 according to an embodiment.

FIG. 5 illustrates an exemplary format of a Group Temporal Key (GTK) command frame 500 according to an embodiment.

### DESCRIPTION OF THE PREFERRED EMBODIMENT(S)

The description that follows presents a series of systems, apparati, methods and techniques that facilitate additional local register storage through the use of a virtual register set in a processor. While much of the description herein assumes a single processor, process or thread context, some realizations in accordance with the present invention provide expanded internal register capability customizable for each processor of a multiprocessor, each process and/or each thread of execution. Accordingly, in view of the above, and without limitation, certain exemplary exploitations are now described.

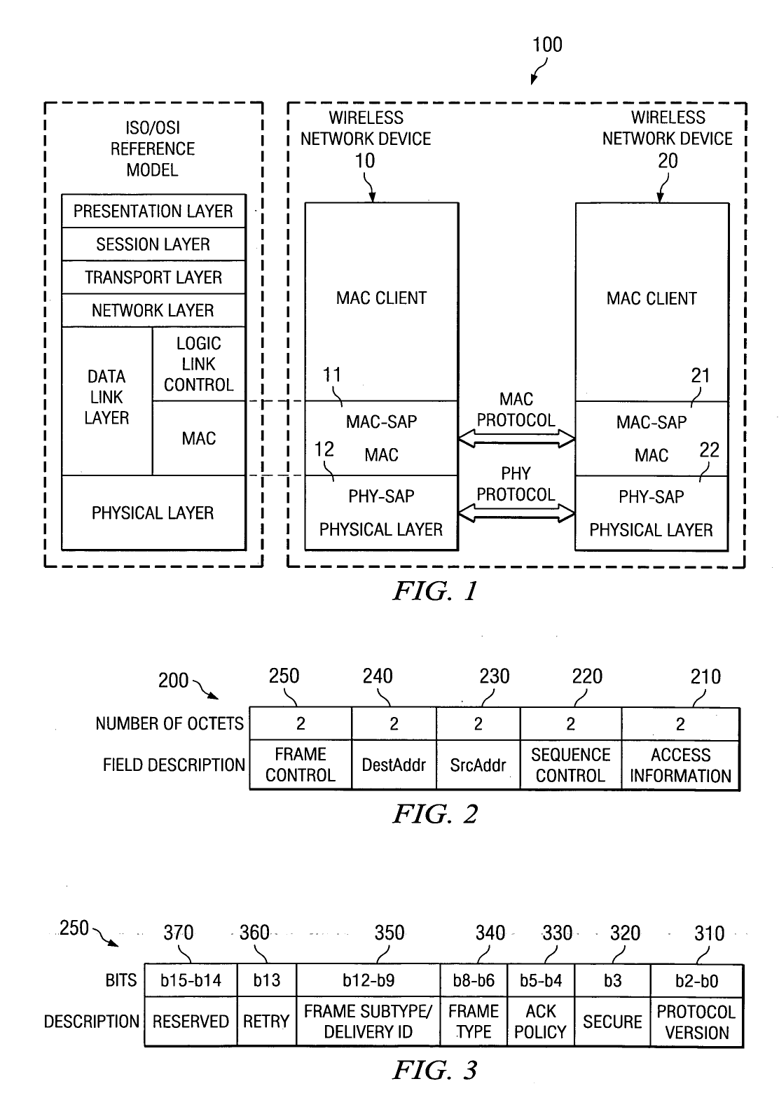

FIG. 1 illustrates the architecture of a distributed wireless network 100 with reference to standard OSI reference model according to an embodiment. The wireless network includes two devices 10 and 20. Devices 10 and 20 can be any device (e.g., laptop computer, video camera, TV, personal digital assistant, mobile phone, and the like) capable of communicating with other devices. Device 10 includes a medium access control (MAC) sublayer 11 and a physical layer (PHY) 12. The MAC sublayer 11 corresponds to the MAC function of the data link layer in the ISO model, while the PHY layer 12 corresponds to the PHY function of the ISO model. Likewise, device 20 includes a MAC sublayer 21 and a PHY layer 22 with a similar correspondence to the ISO model.

The MAC sublayer provides service to the sublayer above itself, or the MAC client, via the MAC service access point (MAC-SAP), and the PHY layer in turn provides service to the MAC sublayer via the PHY-SAP. The communication between MAC sublayers or entities of various devices is done using MAC frames. MAC frames are defined as a sequence of fields in a specific order. MAC frames are delivered to the PHY layer for transmission over a physical channel. According to an embodiment, a MAC frame consists of a fixed-length MAC header and an optional variable-length MAC frame body. The PHY layer adds PHY related parameters to the MAC frame (e.g., a preamble, a PHY header, and the like) to the MAC frame before transmission to facilitate the reception of the frame by the recipient PHY. The MAC and PHY headers are followed by a header check sequence (HCS) inserted in a PHY layer convergence procedure (PLCP) header, while the MAC frame body includes a frame payload and a frame check sequence (FCS). An HCS or FCS is in general a parity check sequence or cyclic redundant check (CRC) for error checking purposes.

The MAC and PHY functions can be implemented in software, hardware, or a combination therefof. For example, a device may include a customized integrated circuit configured for providing PHY interface and MAC functionality along with a processor configured to implement higher-level protocol layers for user interface and establish various sessions according to specific protocol implementation. Similarly, these functions can be integrated into one integrated circuit or provided via an external device configured to communicate with these devices. The MAC and PHY functionalities along with higher-level protocol implementation can be configured in devices such as computers, TV, video camera, personal digital assistant, mobile phone, entertainment systems (DVD players, stereos, etc.) and the like that are desired to be part of the distributed network for communication with each other without an access point.

FIG. 2 illustrates an exemplary format of a MAC header 200 according to an embodiment. The MAC header includes the following fields: Access Information 210, Sequence Control 220, SrcAddr 230, DestAddr 240, and Frame Control 250, each field being two octets long. In the present example, the MAC header 200 is ten octets long; however, the size of the MAC header 200 can be adjusted according to the network and protocol requirements. The Access Information field 210 provides information regarding medium access such as the duration for which a medium is expected to be busy after the end of the PLCP header of the current frame over the wireless medium; information regarding whether more data is to be expected by a recipient after the receipt of the current frame; and the access method used (e.g., distributed reservation protocol, prioritized contention access, and the like). The Sequence Control field 220 identifies the sequence order of MAC service data units (MSDUs), or MAC command data units, and their fragments. The SrcAddr field 230 includes the device address of the transmitting source device, and the DestAddr field 240 includes the device address of the intended recipient (destination) of the current frame. The DestAddr field 240 can identify a single recipient device for a unicast frame, a group of recipient devices for a multicast frame, or all recipient devices in the network for a broadcast frame. The Frame Control field 250 includes various parameters for providing control information for the frame as described below.

FIG. 3 illustrates an exemplary format of the Frame Control filed 250 according to an embodiment. The Frame Control field 250 is two octets (16 bits) long. Bits b0-b2 (310) identify the version of a MAC protocol employed for the data communication. Bit b3 (320) identifies whether the current frame is secure, i.e., if the current frame is protected by security means such as encryption and authentication. Bits b5-b4 (330) define the type of acknowledgement requested by the transmitting device. Bits b8-b6 (340) define the type of the current frame. Table 1 illustrates

TABLE 1
Frame Type field encoding.

| Value | Description |
|---|---|
| 0 | Beacon frame |
| 1 | Control frame |
| 2 | Command frame |
| 3 | Data frame |
| 4 | Aggregated data frame |
| 5-7 | Reserved |

Bits b12-b9 (350) are used as a Frame Subtype field for control and command frames, or as a Delivery ID field for data frames and aggergated data frames, and reserved for all other types of frames. Bit b13 (360) indicates whether the current frame is a retransmission of an earlier frame in any data or command frame, and is considered as reserved for all other types of frames. Bits b15-b14 (370) are reserved for all frame types. Command frames are used to exchange information and manage communication between devices in a network. According to an embodiment, command frames include Pairwise Temporal Key (PTK) and Group Temporal Key (GKT) command frames as further described below.

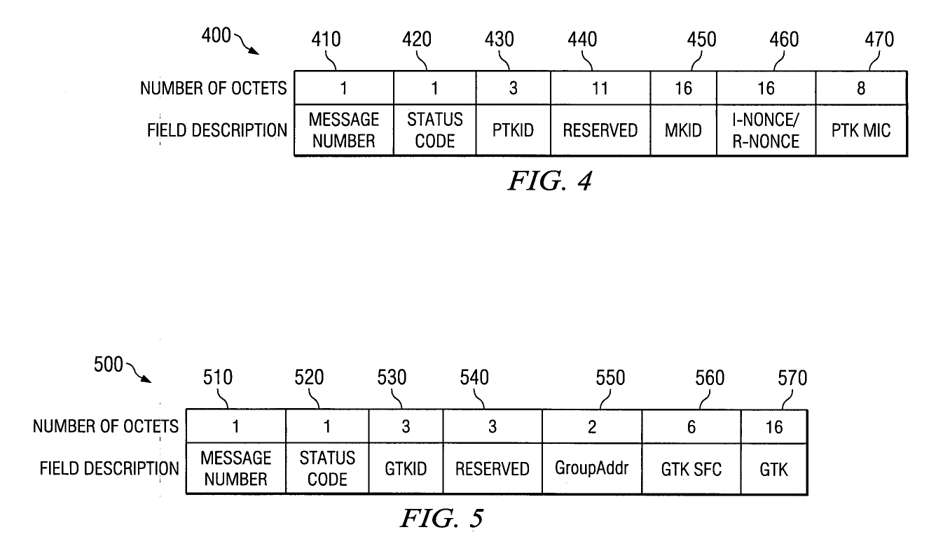

FIG. 4 illustrates an exemplary payload format of a PTK command frame 400 according to an embodiment. The PTK command frame is used in a 4-way handshake by a pair of devices to authenticate each other and to derive a shared symmetric PTK for securing certain unicast traffic between the two devices. The PTK command frame may be a secure or non-secure frame. The payload of the PTK command frame 400 includes the following fields: Message Number 410, Status Code 420, PTKID 430, Reserved 440, MKID 450, I-Nonce/R-Nonce 460, and PTK MIC 470. The length of each field is indicated in FIG. 4.

The Message Number 410 is set to 1, 2, 3, or 4, respectively, in the PTK command containing the first, second, third, or fourth message of the 4-way handshake. The other values of this field are reserved. The Status Code 420 in a PTK command indicates the current status of the 4-way handshake at the device sending this command. It is encoded as shown in Table 2.

TABLE 2
Status Code encoding in a PTK command

| Value | Description |
|---|---|
| 0 | Normal-the 4-way handshake proceeds. |
| 1 | Aborted 0 the 4-way handshake is aborted per security policy. |
| 2 | Aborted-the 4-way handshake is aborted in order to yield to a |
| | concurrent 4-way handshake using the same master key. |
| 3 | PTKID not accepted-it is the TKID of a PTK or GTK being |
| | possessed by this device. |
| 4-255 | Reserved. |

The PTKID 430 is set to a non-zero number as the TKID of the PTK to be derived from this 4-way handshake procedure. The initiator of the 4-way handshake chooses this value after determining that this value is different from the TKID of the PTK, if any, that is to be replaced by the new PTK, and the TKID of any PTK or GTK it currently possesses. The Reserved field 440 is a field currently reserved. The MKID 450 identifies the master key used in this 4-way handshake. The I-Nonce/R-Nonce 460 is a random number generated by the initiator or responder for this 4-way handshake. This field is set to I-Nonce, the random number generated by the initiator in the command containing a Message Number of 1 or 3, and is set to R-Nonce, the random number generated by the responder in the command containing a Message Number of 2 or 4.

The PTK MIC 470 in the PTK command containing a Message Number of 1 is set to 0 on transmission and is ignored on reception. The PTK MIC in the PTK command containing a Message Number of 2, 3, or 4 is set to the MIC that protects the fields in the payload of this command using the PTK MIC generated from the first two messages of the 4-way handshake as specified herein.

FIG. 5 illustrates an exemplary payload format of a GTK command frame 500 according to an embodiment. The GTK command frame is used to solicit or distribute a GTK following a PTK update. The GTK is used to secure certain multicast traffic from a sending device to a group of recipient devices, and is chosen by the sending device. The GTK command frame is always in secure form. The payload of the GTK command frame 500 includes the following fields: Message Number 510, Status Code 520, GTKID 530, Reserved 540, GroupAddr (550), GTK SFC (secure frame counter) 560, and GTK 570. The length of each field is indicated in FIG. 5.

The Message Number 510 is set to 0 in the GTK command transmitted by a multicast recipient device to solicit a new GTK from a multicast sender. The Message Number is set to 1 in the GTK command transmitted by a multicast sender to distribute a new GTK to a multicast recipient. The Message Number is set to 2 in the GTK command transmitted by a multicast recipient device to respond to the distribution of a new GTK command. The Status Code 520 in a GTK command indicates the current status of the GTK solicitation or distribution at the device sending this command. It is encoded as shown in Table 3.

TABLE 3
Status Code encoding in a GTK command

| Value | Description |
|---|---|
| 0 | Normal-GTK solicitation or distribution proceeds. |
| 1 | Rejected-GTK solicitation or distribution is rejected per |
| | security policy. |
| 2 | GTKID not accepted-it is the TKID of a PTK or GTK being |
| | possessed by this device. |
| 3-255 | Reserved. |

The GTKID 530 in the GTK command containing a Message Number of 0 is set to the TKID of the GTK being solicited. It is set to 0 if the soliciting device does not know the TKID of the GTK it is soliciting. The GTKID in the GTK command containing a Message Number of 1 is set to a non-zero number as the TKID of the GTK being distributed. The distributor chooses this value after determining that this value is different from the TKID of the GTK, if any, that is to be replaced by the new GTK, and the TKID of any PTK or GTK the distributor or recipient currently possesses. The GTKID in the GTK command containing a Message Number of 2 is set to the GTKID in the last received GTK command containing a Message Number of 1.

The Reserved field 540 is a field currently reserved. The GroupAddr 550 is set to the McstAddr or BcstAddr for which the GTK is being solicited or distributed. It is set to 0×0001if the GTK is applied to all broadcast and multicast traffic from the device distributing this GTK. The GTK SFC 560 in the GTK command containing a Message Number of 0 is set to 0 on transmission and ignored on reception. The GTK SFC in the GTK command containing a Message Number of 1 is set to the current value of the secure frame counter (SFC) set up for the GTK being distributed. The GTK SFC in the GTK command containing a Message Number of 2 is set to the GTK SFC in the last received GTK command containing a Message Number of 1. The GTK 570 is the GTK distributed by the multicast sender for the McstAddr. In a GTK command soliciting a GTK, the GTK is set to 0 prior to encryption.

According to an embodiment, security service primitives are used to manage the security operation, including the transmission and reception of PTK and GTK commands and the update of PTK and GTK within a device. The service primitives represent the message exchanges between a device management entity (DME) and a medium access protocol (MAC) sublayer management entity (MLME), as further described below.

PTK Establishment

The mechanism supports the procedure of establishing a new PTK with a peer MAC entity. Table 4 lists parameters used in the primitives for establishing a PTK.

TABLE 4
Primitive parameters for PTK establishment

| Name | Type | Valid range | Description |
|---|---|---|---|
| SrcEUI | EUI-48 | Any valid unicast EUI-48 | Specifies the EUI-48 of the |
| | | | device requesting to establish a |
| | | | new PTK by a 4-way handshake |
| | | | as described henceforth |
| DestEUI | EUI-48 | Any valid unicast EUI-48 | Specifies the EUI-48 of the |
| | | | device requested to establish a |
| | | | new PTK by a 4-way handshake |
| | | | as described henceforth |
| MessageNumber | Integer | Any valid positive number | Specifies the number of the |
| | | as specified henceforth | message being conveyed in the |
| | | | 4-way handshake |
| StatusCode | Integer | Any valid value as specified | Specifies the status of the 4-way |
| | | henceforth | handshake |
| PTKID | Integer | A non-zero number as | Specifies the TKID of the new |
| | | specified henceforth | PTK established by the 4-way |
| | | | handshake |
| MKID | Octet string | 16 octets as specified | Identifies the master key used to |
| | | henceforth | establish a new PTK by a 4-way |
| | | | handshake |
| PTK | Octet string | 16 octets as specified | Specifies the new PTK |
| | | henceforth | established by the 4-way |
| | | | handshake |
| PTKFailureTimeout | Integer | ≧1 | Specifies a time limit in |
| | | | microseconds after which the |
| | | | procedure of establishing a new |
| | | | PTK must be terminated |
| ResultCode | Enumeration | RESPONSE_RECEIVED, | Indicates the result of the |
| | | INVALID_PARAMETERS, | corresponding MLME- |
| | | TIMEOUT | PTK.request |

MLME-PTK.Request

This primitive requests establishment of a new PTK with a specified peer MAC entity as described henceforth.

The semantics of this primitive are:

| | |
|---|---|
| MLME-PTK.request | ( |

DestEUI,
MessageNumber,
StatusCode,
PTKID,
MKID,
PTKFailureTimeout
)

When generated: This primitive is generated by the DME for the local MAC entity to start a 4-way handshake procedure to establish a new PTK with a specified peer MAC entity. This primitive is also generated by the DME for the local MAC entity to continue with an ongoing 4-way handshake procedure upon receiving a valid PTK command containing a Message Number of 2 and a StatusCode of zero.

Effect of receipt: The local MAC entity initiates or continues with a 4-way handshake using the master key specified by the MKID parameter to establish a new PTK with a specified peer MAC entity specified by the DestEUI field. If the MessageNumber in the MLME-PTK.request is 1, then the local MAC entity generates a new random number as the I-Nonce and transmits a PTK command containing the first message of the 4-way handshake to the specified peer MAC entity. If the MessageNumber in the MLME-PTK.request is 3, then the local MAC entity uses its I-Nonce generated for the first message of the same 4-way handshake and transmits a PTK command containing the third message of the 4-way handshake to the specified peer MAC entity. The MLME subsequently issues an MLME-PTK.confirm to reflect the results.

MLME-PTK.Indication

This primitive reports the request or establishment of a new PTK with a specific peer MAC entity.

The semantics of this primitive are:

| | |
|---|---|
| MLME-PTK.indication | ( |

SrcEUI,
MessageNumber,
StatusCode,
PTKID,
PTK,
MKID
)

When generated: This primitive is generated by the MLME as a result of the request or establishment of a new PTK with a specific peer MAC entity via a 4-way handshake procedure. Specifically, the primitive is generated by the MLME upon receiving a valid PTK command containing a Message Number of 1 or 3.

Effect of receipt: The DME is notified of the request or establishment of a new PTK. The DME subsequently issues an MLME-PTK.response to reflect the actions taken. If the MessageNumber in the MLME-PTK.indication is one, the DME verifies that the proposed PTKID is not being used by the local MAC entity for any temporal key and that establishing a new PTK using the MKID with the requesting DME is an acceptable action. The DME includes the results of the verification in the StatusCode parameter of the MLME-PTK.response. If the MessageNumber in the MLME-PTK.indication is 3 and the StatusCode in the MLME-PTK.response is zero, the DME issues an MLME-KEY-UPDATE.request.

MLME-PTK.Response

This primitive responds to the request or establishment of a new PTK with a specific peer MAC entity.

The semantics of this primitive are:

| | |
|---|---|
| MLME-PTK.response | ( |

SrcEUI,
MessageNumber,
StatusCode,
PTKID,
MKID
)

When generated: This primitive is generated by the DME as a result of an MLME-PTK.indication reporting a valid request or establishment of a new PTK with a specific peer MAC entity via a 4-way handshake procedure.

Effect of receipt: If the MessageNumber is 2, the MAC entity generates a new random number as the R-Nonce and transmits a PTK command containing the second message of the 4-way handshake to the specific peer MAC entity. If the MessageNumber is 4, the MAC entity uses its R-Nonce generated for the second message of the same 4-way handshake and transmits a PTK command containing the fourth message of the 4-way handshake to the specific peer MAC entity. The PTK command carries the StatusCode parameter in its Status Code field.

MLME-PTK.Confirm

This primitive reports the results of the attempt to establish a new PTK with a specified peer MAC entity.

The semantics of this primitive are:

| | |
|---|---|
| MLME-PTK.confirm | ( |

DestEUI,
MessageNumber,
StatusCode,
PTKID,
PTK,
MKID,
ResultCode
)

When generated: This primitive is generated by the MLME as a result of an MLME-PTK.request to establish a new PTK with a specified peer MAC entity. Specifically, the primitive is generated by the MLME upon receiving a valid PTK command containing a Message Number of 2 or 4; or generated in case of INVALID_PARAMETERS or PTKFailureTimeout.

Effect of receipt: The DME is notified of the intermediate or final results of procedure to establish a new PTK with a specified peer MAC entity. If the MesageNumber is 4, the StatusCode is zero, and the ResultCode is RESPONSE_RECEIVED, the DME follows to issue an MLME-KEY-UPDATE.request.

GTK Solicitation/Distribution

The mechanism supports the procedure of soliciting a new GTK from, or distributing a new GTK to, a peer MAC entity. Table 5 lists the parameters used in the primitives for soliciting or distributing a GTK.

TABLE 5
Primitive parameters for GTK solicitation or distribution

| Name | Type | Valid range | Description |
|---|---|---|---|
| SrcEUI | EUI-48 | Any valid unicast EUI-48 | Specifies the EUI-48 of the |
| | | | device soliciting or distributing |
| | | | a new GTK |
| DestEUI | EUI-48 | Any valid unicast EUI-48 | Specifies the EUI-48 of the |
| | | | device requested to distribute or |
| | | | receive a new GTK |
| TKID | Integer | A non-zero number as | Identifies the PTK used to |
| | | specified henceforth | distribute the new GTK |
| MessageNumber | Integer | Any valid positive number | Specifies the number of the |
| | | as specified henceforth | message being conveyed in the |
| | | | GTK solicitation or distribution |
| | | | process |
| StatusCode | Integer | Any valid value as specified | Specifies the status of the GTK |
| | | henceforth | solicitation or distribution |
| | | | process |
| GTK | Octet string | 16 octets as specified | Specifies the new GTK being |
| | | henceforth | distributed |
| GTKID | Integer | A non-zero number as | Specifies the TKID of the new |
| | | specified henceforth | GTK being solicited or |
| | | | distributed |
| GroupEUI | EUI-48 | Any valid multicast or | Specifies the multicast group for |
| | | broadcast EUI-48 | which the GTK is being |
| | | | solicited or distributed, or |
| | | | specifies the GTK is for |
| | | | broadcast |
| Global | Boolean | FALSE, TRUE | If TRUE, indicates that the GTK |
| | | | update applies to all broadcast |
| | | | and multicast traffic from the |
| | | | device that distributed this GTK. |
| | | | If FALSE, indicates the update |
| | | | applies only to the specific |
| | | | GroupEUI identified. |
| GTKFailureTimeout | Integer | ≧1 | Specifies a time limit in |
| | | | microseconds after which the |
| | | | procedure of soliciting or |
| | | | distributing a new GTK must be |
| | | | terminated |
| ResultCode | Enumeration | RESPONSE_RECEIVED, | Indicates the result of the |
| | | INVALID_PARAMETERS, | corresponding MLME- |
| | | TIMEOUT | GTK.request |

MLME-GTK.Request

This primitive requests that the MAC entity solicit a new GTK from, or distribute a new GTK to, a specified peer MAC entity as described henceforth.

The semantics of this primitive are:

| | |
|---|---|
| MLME-GTK.request | ( |

DestEUI,
TKID,
MessageNumber,
StatusCode,
Global,
GTK,
GTKID,
GroupEUI,
GTKFailureTimeout
)

When generated: This primitive is generated by the DME for the local MAC entity to solicit a new GTK from, or distribute a new GTK to, a specified peer MAC entity.

Effect of receipt: The MAC entity initiates a new GTK solicitation or distribution procedure, based on the value of MessageNumber. If MessageNumber is zero, the MAC entity transmits a GTK command soliciting a new GTK from the specified peer MAC entity. If MessageNumber is one, the MAC entity distributes a new GTK to the specified peer MAC entity. The MLME subsequently issues an MLME-GTK.confirm to reflect the results.

MLME-GTK.Indication

This primitive reports the solicitation or distribution of a new GTK by a specific peer MAC entity.

The semantics of this primitive are:

| | |
|---|---|
| MLME-GTK.indication | ( |

SrcEUI,
TKID,
MessageNumber,
StatusCode,
Global,
GTK,
GTKID,
GroupEUI
)

When generated: This primitive is generated by the MLME as a result of receiving a valid solicitation or distribution of a new GTK from a specific peer MAC entity.

Effect of receipt: The DME is notified of the solicitation or distribution of a new GTK. If the received MessageNumber is zero, and if the DME accepts the solicitation for a new GTK, it subsequently issues an MLME-GTK.request to distribute a new GTK. If the received MessageNumber is one, the DME subsequently issues an MLME-GTK.response to reflect the actions taken with respect to the distribution of a new GTK. If the StatusCode in the MLME-GTK.response is zero, the DME follows to issue an MLME-KEY-UPDATE.request.

MLME-GTK.Response

This primitive responds to the solicitation or distribution of a new GTK by a specific peer MAC entity.

The semantics of this primitive are:

| | |
|---|---|
| MLME-GTK.response | ( |

SrcEUI,
TKID,
MessageNumber,
StatusCode,
GTK,
GTKID,
GroupEUI
)

When generated: This primitive is generated by the DME as a result of an MLME-GTK.indication reporting a distribution of a new GTK from a specific peer MAC entity.

Effect of receipt: The MAC entity transmits a GTK command responding to the distribution of a new GTK from the specific peer MAC entity. The GTK command carries the StatusCode parameter in its Status Code field.

MLME-GTK.Confirm.

This primitive reports the results of the attempt to solicit a new GTK from, or distribute a new GTK to, a specified peer MAC entity.

The semantics of this primitive are:

| | |
|---|---|
| MLME-GTK.confirm | ( |

DestEUI,
TKID,
MessageNumber,
StatusCode,
GTK,
GTKID,
GroupEUI,
ResultCode,
)

When generated: This primitive is generated by the MLME as a result of an MLME-GTK.request to solicit a new GTK from, or distribute a new GTK to, a specified peer MAC entity. Specifically, the primitive is generated by the MLME upon successfully transmitting a GTK command soliciting a new GTK or upon successfully receiving a GTK command responding to the distribution of a new GTK; the primitive is also generated in case of INVALID_PARAMETERS or GTKFailureTimeout.

Effect of receipt: The DME is notified of the results of the procedure to solicit a new GTK from, or distribute a new GTK to, a specified peer MAC entity.

Temporal Key Update

The mechanism supports the procedure of installing or deleting either a PTK or a GTK. Table 6 lists the parameters used in the primitives for updating a temporal key, a PTK or GTK.

TABLE 6
Primitive parameters for PTK or GTK installation or deletion

| Name | Type | Valid range | Description |
|---|---|---|---|
| PeerEUI | EUI-48 | Any valid unicast EUI-48 | For a PTK, specifies the EUI-48 of |
| | | | the peer device sharing the PTK |
| | | | being updated. For a GTK, specifies |
| | | | the EUI-48 of the device which |
| | | | distributed the GTK being updated. |
| GroupEUI | EUI-48 | Any valid multicast or | Specifies the multicast or broadcast |
| | | broadcast EUI-48 | EUI-48 to which the new GTK |
| | | | applies. |
| KeyType | Enumeration | PTK, GTK | Indicates whether the update is for a |
| | | | PTK or GTK |
| Global | Boolean | FALSE, TRUE | If TRUE, indicates that the GTK |
| | | | update applies to all broadcast and |
| | | | multicast traffic from the device that |
| | | | distributed this GTK. If FALSE, |
| | | | indicates the update applies only to |
| | | | the specific GroupEUI identified. |
| TKID_Old | Integer | A non-zero number as | Specifies the TKID of the old PTK or |
| | | specified henceforth, or zero | GTK being replaced. If zero, |
| | | | indicates no old PTK or GTK is |
| | | | being replaced. |
| TKID | Integer | A non-zero number as | Specifies the TKID of the new PTK |
| | | specified henceforth, or zero | or GTK being installed. If zero, |
| | | | indicates no new PTK or GTK is |
| | | | being installed. |
| KEY | Octet string | 16 octets as specified | Specifies the new PTK or GTK being |
| | | henceforth | installed |
| ResultCode | Enumeration | SUCCESS, | Indicates the result of the |
| | | INVALID_PARAMETERS | corresponding MLME-KEY- |
| | | | UPDATE.request |

MLME-KEY-UPDATE.Request

This primitive requests an update of a specified PTK or GTK.

The semantics of this primitive are:

| | |
|---|---|
| MLME-KEY-UPDATE.request | ( |

PeerEUI,
GroupEUI,
KeyType,
Global,
TKID_Old,
TKID,
KEY
)

When generated: This primitive is generated by the DME for the local MAC entity to update a PTK or GTK.

Effect of receipt: The MLME removes the keying credential identified by TKID_Old that was previously installed if TKID_Old is not zero. The MLME then installs the new PTK or GTK along with the TKID for the specified (PeerEUI, GroupEUI) if TKID is not zero. The MLME subsequently issues an MLME-KEY-UPDATE.confirm to reflect the results.

MLME-KEY-UPDATE.Confirm.

This primitive reports the results of the attempt to update a PTK or GTK.

The semantics of this primitive are:

| | |
|---|---|
| MLME-KEY-UPDATE.confirm | ( |

PeerEUI,
GroupEUI,
TKID_Old,
TKID,
KEY,
ResultCode
)

When generated: This primitive is generated by the MLME as a result of E-KEY-UPDATE.request to update a PTK or GTK.

Effect of receipt: The DME is notified of the results of the procedure to update a specified PTK or GTK.

Security Violation Report

The mechanism supports the procedure of reporting a security violation. Table 7 lists the parameters used in the primitives for reporting a security violation.

TABLE 7
Primitive parameters for security violation report

| Name | Type | Valid range | Description |
|---|---|---|---|
| ViolationCode | Enumeration | INVALID_MODE, | Indicates the |
| | | INVALID_MIC, | cause of a |
| | | INVALID_TKID, | security |
| | | REPLAYED_FRAME | violation |

MLME-SECURITY-VIOLATION.Indication

This primitive reports a security violation.

The semantics of this primitive are:

| | |
|---|---|
| MLME-SECURITY-VIOLATION.indication | ( |
| | ViolationCode |
| | ) |

When generated: This primitive is generated by the MLME as a result of encountering a security violation.

Effect of recipet: The DME is notified of the cause of the security violation.

According to an embodiment, two devices in a distributed wireless network use a 4-way handshake mechanism to derive a pair-wise temporal key (PTK) while authenticating their identities to each other. The devices establish a secure communication relationship following a successful 4-way handshake. The 4-way handshke between two devices is conducted using a shared master key. The devices obtain shared master keys using various known methods. Further, following a successful 4-way handshake, devices solicit and distribute group temporal keys (GKTs). While PTKs are used for protecting unicast frames exchanged between two devices, GTKs are used to protect multicast and broadcast frames that are transmitted by a device to a multicast or broadcast group of recipient devices.

A device can initiate a 4-way handshake with another device after determining that the device shares a master key with the other device. Two devices can establish a PTK via a 4-way handshake for each master key they share. The master key is not exposed in the 4-way handshake, but is instead specified by a master key identifier (MKID). Devices may advertise some or all of the MKIDs they possess in an MKID information element (IE) in their beacons. A first device may probe a second device for the MKIDs possessed by that device by addressing an appropriate Probe IE in a beacon or Probe command to that device. The second device then lists all the MKIDs it possesses in the MKID IE in response to a probe request for its MKIDS.

According to an embodiment, the 4-way handshake to derive a PTK, the GTK solicitation or distribution, and PTK or GTK installation or deletion are managed through service primitives as described in the above. The 4-way handshake uses messages contained in PTK command frames as described in the above. The GKT solicitation or distribution uses messages contained in GTK command frames as described in the above.

The 4-way handshake is employed to provide mutual authentication and PKT generation for two devices sharing a master key. To perform a 4-way handshake between two devices, a first device assumes the roles of “initiator” and the second device assumes the role of a “responder”. According to an embodiment, a 4-way handshake consists of four messages, message 1, message 2, message 3, and message 4. These messages are sent back and forth between the two devices. The first device sending message 1 becomes the initiator. The second device becomes the responder.

b 4-Way Handshake Message 1

The initiator begins a 4-way handshake by composing and sending message 1 in a PTK command to the responder. In this command, the initiator specifies the MKID for use in the 4-way handshake, proposes a temporal key identification (TKID) for the PTK to be derived, and includes a unique 128-bit cryptographic random number, I-Nonce. The proposed TKID is preferably different from any TKID currently installed in the initiator's local MAC entity or being used in an in-progress 4-way handshake involving this initiator device. The random number I-Nonce is generated anew each time the initiator starts a new 4-way handshake.

Upon receiving message 1, the responder verifies that the requested TKID is unique (i.e., not currently installed for an active temporal key or requested by an in-process 4-way handshake exchange). The responder then performs the following steps:
a. Generate a new 128-bit cryptographic random number, R-Nonce.
b. Derive the PTK and key confirmation key (KCK) as describer below, and
c. Construct and send message 2 in a PTK command.
   4-Way Handshake Message 2

In message 2, the responder includes an appropriate Status Code, the newly generated R-Nonce, and a PTK message integrity code (MIC) value computed for the message using the newly derived KCK as described herein below. If the proposed TKID in the message 1 is not unique, the responder indicates so in the Status Code.

Upon receiving message 2, the initiator performs the following steps:
a. Derive the PTK and KCK;
b. Recalculate the PTK MIC for the received message using the KCK as also described herein below;
c. If the recalculated PTK MIC does not match the PTK MIC field from this message, discard and disregard message 2 and abort the 4-way handshake. Otherwise, consider this message a proof that the responder holds the correct master key, and proceed to the next step.
d. Check the Status Code returned in the received message. If the Status Code indicates an abortion of the 4-way handshake by the responder, then stop the 4-way handshake. If the Status Code indicates a conflict of the proposed TKID at the responder, then restart the 4-way handshake with a different TKID. If the Status Code indicates a normal status, then proceed to the next step.
e. Construct and send message 3 in a PTK command.
   4-Way Handshake Message 3

In message 3, the initiator includes the same I-Nonce as included in message 1 and a PTK MIC computed for this message using the newly derived KCK. Upon receiving message 3, the responder performs the following steps:
a. Verify the PTK MIC for this message using the KCK as further described herein below. If the calculated PTK MIC does not match the PTK MIC field from this message, then discard and disregard message 3 and abort the 4-way handshake. Otherwise, consider this message a proof that the initiator holds the correct master key, and proceed to the next step.
b. Construct and send message 4 in a PTK command; and
c. Install the PTK.
   b 4-Way Handshake Message 4

In message 4, the responder includes the same R-Nonce as contained in message 2 and a PTK MIC computed for this message using the KCK.

Upon receiving message 4, the initiator performs the following steps:
a. Verify the PTK MIC for this message using the KCK as further described herein below. If the calculated PTK MIC does not match the PTK MIC field from this message, discard and disregard message 4 and abort the 4-way handshake. Otherwise, install the PTK.

According to an embodiment, upon successful completion of a 4-way handshake and installation of the resulting PTK, the initiator and responder use GTK command frames (with Message Number set to 1) to distribute their respective GTKs for broadcast traffic to each other. Each may also use a GTK command to distribute a GTK for protecting certain multicast traffic to an intended recipient with which it holds a valid PTK. Upon receiving a valid GTK command frame marked as Message Number 1, a device verifies that the GTK ID is a unique TKID. The device then responds with a GTK command frame with Message Number set to 2 and Status Code set to the appropriate value.

A recipient device may request a GTK for certain multicast traffic in the form of a GTK command (with Message Number set to 0) from the source device if it holds a valid PTK with the source. Upon receiving a valid GTK command marked as Message Number 0, the multicast source device responds with a GTK command marked as Message Number 1, which may or may not contain the requested GTK. The requesting device, upon receiving this GTK command and verifying the uniqueness of the proposed TKID, returns a GTK command with Message Number set to 2 and Status Code set to the appropriate value.

A source device distributing a GTK checks the Status Code indicated in the returned GTK command (Message Number set to 2). If the Status Code indicates a conflict of the proposed TKID at the recipient device, the source device proposes a new TKID and re-distributes the GTK to the recipient. After receiving a returned GTK command from the recipient with the Status Code indicating a normal status, the source device uses the new TKID to re-distribute the GTK to each of the devices to which it has previously distributed the GTK and with which it maintains a secure relationship.

A device then installs a newly distributed or received GTK. A GTK is a 128-bit cryptographic-grade random number. A new GTK is generated when the distributing device establishes a new group relationship. According to an embodiment, a pseudo random function (PRF) is defined and used for the 4-way handshake and other security operations. Depending on the use, the PRF may output values of 64 bits, 128 bits, and 256 bits, and is designated as PRF-64, PRF-128, and PRF-256, respectively. In the following, Kdenotes a 128-bit symmetric key, N denotes a 13-octet nonce value, A denotes a unique 14-octet ASCII text label for each different use of the PRF, B denotes the input data stream, Blen specifies the length of this data stream, and ∥ denotes concatenation. Blocks are each 16 octets long, and are defined as inputs to an AES-128 CCM for the MIC generation.

```
CCM-MAC-FUNCTION(K, N, A, B, Blen)
begin
  Form authentication block B_0 from flags = 0x59, N, and l(m) = 0
  Form authentication block B_1 from l(a) = 14 + Blen and A
  Form additional authentication blocks from B
    (with last block zero padded as needed)
  Form encryption block A_0 from flags = 0x01, N, and Counter_0 = 0
  R [symbol] MIC (K, B_0, B_1, ..., A_0)
return R
PRF(K, N, A, B, Blen, Len)
  For i [symbol] 1 to ( Len + 63)/64 do
    R [symbol] R || CCM-MAC-FUNCTION(K, N, A, B, Blen)
    N [symbol] N + 1
return L(R, 0, Len) = Len most-significant bits of R
PRF-64(K, N, A, B, Blen) = PRF(K, N, A, B, Blen, 64)
PRF-128(K, N, A, B, Blen) = PRF(K, N, A, B, Blen, 128)
PRF-256(K, N, A, B, Blen) = PRF(K, N, A, B, Blen, 256)
```

To generate the PTK and KCK associated with a 4-way handshake, a 256-bit PRF is used based on the following parameters as defined in Table 8 that follows:
K—The PMK (pairwise master key)
N—B12-11=InitiatorDevAddr, B10-9=ResponderDevAddr, B8-6=PTKID, B5-0=zero
A—“Pair-wise keys”
B—I-Nonce∥R-Nonce

Blen—32

TABLE 8
Parameters for PTK and KCK generation.

| | Size | |
|---|---|---|
| Name | (octets) | Description |
| InitiatorDevAddr | 2 | DevAddr of device with role of initiator |
| ResponderDevAddr | 2 | DevAddr of device with role of responder |
| I-Nonce | 16 | Random number selected by initiator |
| | | (in message 1) |
| R-Nonce | 16 | Random number selected by responder |
| | | (in message 2) |
| PTKID | 3 | Negotiated TKID value for the PTK to |
| | | be derived (in message 1) |
| PMK | 16 | A pre-shared pair-wise master key |
| | | identified by the MKID (in message 1) |

A 256-bit PRF-256 is called with the parameters define in Table 8 to compute a 256-bit key stream:
KeyStream←PRF-256(K, N, A, B, Blen)

This key stream is then split to form the desired PTK and KCK connection with the 4-way handshake as described above. The least significant 16 octets of KeyStream become the KCK while the most significant 16 octets become the PTK, as illustrated in Table 9.

TABLE 9
KCK and PTK in KeyStream

| Key | Source |
|---|---|
| KCK | KeyStream octets 0-15 |
| PTK | KeyStream octets 16-31 |

To generate a PTK MIC, the 4-way handshake uses an “out-of-band MIC” calculation for the PTK MIC field in handshake messages 2-4. A PRF with 64-bit output is used to provide the PTK MIC calculation. The PRF-64 parameters are defined as follows based on Table 8 given above.
K—The KCK
N—B12-11=InitiatorDevAddr, B10-9=ResponderDevAddr, B8-6=PTKID, B5-0=zero
A—“out-of-bandMIC”
B—Fields from Message Number to I-Nonce/R-Nonce contained in the PTK command
Blen—length in octets of B=48
PTK MIC←PRF-64(K, N, A, B, Blen)

Realizations in accordance with the present invention have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the exemplary configurations may be implemented as a combined structure or component. These and other variations, modifications, additions, and improvements may fall within the scope of the invention as defined in the claims that follow.

1. A method of establishing communication between devices in a distributed network comprising:
determining whether a first device shares a master key with a second device;
if the first device shares a master key with the second device, then exchanging a plurality of messages between the first and second devices for deriving a pair-wise temporal key (PTK) for secure communication between the first and second devices.

2. A method according to claim 1, further comprising:
exchanging a plurality of messages between the first and second devices to one or more of distributing and soliciting a group temporal key.

3. A method according to claim 1, further comprising:
sending a first message from the first device to the second device, wherein the first message includes at least a first message number, a proposed PTK identification (PTKID), a first status code, a master key identification (MKID) identifying the shared master key, a first random number, and a first PTK message integrity code (MIC) of zero.

4. A method according to claim 3, further comprising:
upon receiving the first message at the second device, generating a second random number;
deriving the PTK;
deriving a key confirmation key (KCK); and
sending a second message to the first device, wherein the second message includes at least a second message number, a second status code, the proposed PTKID contained in the first message, the MKID contained in the first message, a second random number, and a second PTK MIC calculated using the KCK.

5. A method according to claim 4, wherein the first and second random numbers are 128-bit cryptographic random numbers.

6. A method according to claim 4, further comprising:
upon receiving the second message at the first device, deriving the PTK and KCK from the second message;
verifying the second PTK MIC using the KCK;
if the second PTK MIC is not verified, then aborting the PTK derivation with the second device.

7. A method according to claim 6, further comprising:
if the second PTK MIC is verified, and if the second status code indicates a normal status, then sending a third message to the second device, wherein the third message includes at least a third message number, a third status code, the proposed PTKID included in the first message, the MKID included in the first message, the first random number, and a third PTK MIC calculated using the KCK.

8. A method according to claim 7, further comprising:
if the status code indicates abortion of the PTK derivation, then aborting the PTK derivation with the second device.

9. A method according to claim 7, further comprising:
if the status code indicates a conflict of the proposed PTKID, then resending the first message with a different PTKID and a different first random number.

10. A method according to claim 7, further comprising:
upon receiving the third message at the second device, verifying the third PTK MIC using the KCK;
if the third PTK MIC is verified, then sending a fourth message to the first device, and
installing the PTK for secure communication with the first device, wherein the fourth message includes at least a fourth message number, a fourth status code, the proposed PTKID included in the first message, the MKID included in the first message, the second random number included in the second message, and a fourth PTK MIC calculated using the KCK.

11. A method according to claim 10, further comprising:
if the third PTK MIC is not verified, then aborting the PTK derivation with the first device.

12. A method according to claim 10, further comprising:
upon receiving the fourth message at the first device, verifying the fourth PTK MIC using the KCK;
if the fourth PTK MIC is verified, then installing the PTK for secure communication with the second device; and
if the fourth PTK MIC is not verified, then aborting the PTK derivation with the second device.

13. A method according to claim 2, further comprising:
sending at least one group temporal key (GTK) from the first device to the second device in a first GTK message, wherein the first GTK message further includes at least a first message number, a first status code, a proposed GTK identification (GTKID), a Group Address (GroupAddr), and a GTK secure frame counter (SFC).

14. A method according to claim 13, further comprising:
upon receiving the first GTK message at the second device, verifying the uniqueness of the proposed GTKID compared to one or more other GTKIDs currently being used by the second device;
if the proposed GTKID is unique, then sending a second GTK message to the first device, wherein the second GTK message includes at least a second message number, a second status code indicating a normal status, the proposed GTKID included in the first GTK message, the GroupAddr, the GTK SFC, and the GTK included in the first message; and
installing the GTK at the second device for reception of one or more of broadcast and multicast data from the first device.

15. A method according to claim 2, further comprising:
at the first device, soliciting a GTK from the second device using a first GTK message, wherein the second device is a multicast source device and the first GTK message includes at least a first message number, a first status code, a GTKID, a GroupAddr, a GTK secure frame counter (SFC), and a GTK field;
upon receiving the first GTK message at the second device, sending a second GTK message to the first device, wherein the second GTK message includes a proposed GTKID and the GTK solicited by the first device;
upon receiving the second GTK message at the first device, verifying the uniqueness of the proposed GTK TKID compared to one or more GTK TKID used by the first device, and if the GTK TKID is unique, then sending a third GTK message to the second device; and
installing the GTK at the first device for multicast reception from the second device.

16. A method according to claim 1, wherein a device management entity function at the first device initiates the deriving PTK.

17. A method according to claim 2, wherein device management entities of corresponding first and second devices request their corresponding local media access control functions to one or more of distributing or soliciting the group GTK.
